(19) United States
(12) Patent Application Publication
(10) Pub. No.: US 2008/0126190 A1
(43) Pub. Date: May 29, 2008

(54) Method of Providing Clothing by Subscription

(76) Inventor: Christopher James Gosnell, Golden, CO (US)

Correspondence Address: Leyendecker & Lemire, LLC, C/O PORTFOLIO IP, P.O. BOX 52050, MINNEAPOLIS, MN, 55402, US

(21) Appl. No.: 11/534,744

(22) Filed: Sep. 25, 2006

(51) Int. Cl. G06Q 30/00; G06Q 99/00

(52) U.S. Cl. 705/14; 700/130; 705/26; 705/1; 705/40

(57) ABSTRACT

Embodiments comprise a method of providing clothing through a subscription service. Subscribers are enrolled into the service. A lifestyle profile category is selected for each subscriber and information concerning each subscriber's clothing sizes is obtained. Periodically, clothing is chosen for each subscriber based in part on his lifestyle profile category without additional input from the subscriber. The clothing is then delivered to each subscriber in the subscriber's size.

### FIELD OF THE INVENTION

The present invention pertains generally to a method of providing products, such as clothing, by subscription.

### BACKGROUND

For many people and, more typically, young professional men selecting suitable clothes for work and play that are in style can be difficult if not extremely frustrating. Often young male professionals lean on girlfriends and other female friends to help pick out their clothing. When men get married they often leave the clothing selection to their spouses who may have a better fashion sense.

Left alone, many men tend to pick outfits that are out of style, inappropriate for a particular use, of poor quality and/or do not match. Accordingly, some single men revert to buying only safe clothes, such as jeans, slacks and polo-type shirts rather than risk the condemnation or ridicule of those who are more fashion conscience. Unfortunately, by playing it safe, they may not receive the notice of those they are wishing would notice them whether it is a women in a social setting or a superior in a business setting.

Of course, a busy single professional man can head to the local mall and peruse the clothing stores, relying on the advice of clerks in picking clothing. This can work but more often than not the clerk is a fashion professional and will accordingly dress the customer in clothes he or she thinks looks good on the customer and not what is most appropriate for the customer. Another problem with purchasing clothes in clothing stores is that it can be extremely time consuming and take away from more important or enjoyable activities. Some men, do have a fashion sense but because of their busy schedules just do not prioritize the time to shop.

Most major clothing retailers have web-based portals in addition to brick and mortar locations. Further, online and mail order only clothing stores also exist. Online clothing stores do have a number of features that assist a customer in choosing clothes such as applets that suggests a size for a particular piece of clothing based on user provided measurements. Other applets are known or taught that create avatars for the customer and permit him or her to dress the avatar with clothes he or she is considering. In yet another online store concept, a customer selects the fashion category he/she is interested in and provides his/her body type, and clothes in the category matching the body type are displayed.

While the online stores save a customer the time of driving to and from a brick and mortar store, the interaction with a clerk that can help select clothing is lost. In fact, the features and applets provided in relation to online stores are provided primarily to make the online experience as close as possible to the in store shopping experience. Even with such features it is generally recognized that online clothing shopping is still more difficult than in store shopping. Accordingly, there is no reason to believe that a fashion inept single man would be anymore capable of choosing suitable clothes online even with some of the aforementioned applets and features and there is reason to conclude that prior art online shopping would only exacerbate the problem.

### BRIEF DESCRIPTION OF THE DRAWINGS

FIG. 1 illustrates an exemplary computer system upon which embodiments of the invention may be implemented.

FIG. 2 is an illustration of a typical subscription service system coupled with an associated network and various associated computers and information appliances according to one embodiment of the present invention.

FIG. 3 is a list of lifestyle profiles from which a subscriber can choose the one that best describes him according to one embodiment of the present invention.

FIG. 4 is a partial exemplary list of questions from a lifestyle questionnaire wherein a subscriber completes the questionnaire and based on the results the subscriber is assigned a particular lifestyle category according to one embodiment of the present invention.

FIG. 5 is a flow chart illustrating a process of operating a clothing subscription service according to one embodiment of the present invention.

FIG. 6 is a flow chart illustrating a process of enrolling a new subscriber according to one embodiment of the present invention.

FIG. 7 is a flow chart illustrating a process of assigning a lifestyle profile category to a subscriber according to one embodiment of the present invention.

### DETAILED DESCRIPTION

Embodiments of the invention comprise a method of providing goods by way of a subscription service. In one embodiment described in detail herein, the method and associated systems pertain to clothing and is directed towards single professional men. The method and system of this embodiment ameliorate many of the problems some single men have in buying stylish clothes for themselves. Quite simply, the customer, once he has subscribed to the service, never has to worry about picking clothes or going shopping as pre-selected clothing in his size that matches his lifestyle is shipped to him periodically.

The customer makes his lifestyle profile choice when initially enrolling in the service by any one of several methodologies. For instance, in one embodiment, he may simply read a listing of different lifestyle profile choices and pick the one that best describes him or his situation. In another embodiment, the customer may answer a questionnaire and the system determines his lifestyle profile category based on the provided answers. In some embodiments a customer may be able to more fully customize his lifestyle profile by providing information, such as but not limited to information concerning (i) the climate where he resides, (ii) his hair, skin and eye colors, and (iii) his body type. Based on this additional information, the customer may be placed in an appropriate subcategory.

In addition to choosing a lifestyle profile category, the customer provides body measurements and selects his subscription level. Finally, the customer provides billing information, such as a credit card information, is provided and an authorization to periodically bill the credit card the agreed upon amount.

After enrollment on a periodic basis the customer is shipped a selection of clothing. The received clothing relates to the customer's lifestyle profile, and as applicable in certain embodiments, instructions concerning the coordination and use of the received clothing will be provided. In yet other embodiments, outfit coordination information for the new articles of clothing may also be provided in relation to all articles previously shipped to the customer.

In embodiments, the actual clothes provided to subscribers are chosen by fashion consultants and/or fashion professionals for each of the lifestyle profile categories and in certain circumstances the subcategories. A fashion consultant need only pick a limited number of clothing sets typically corresponding to the number of lifestyle profiles rather than individually pick clothing for each customer. Accordingly, the number of subscribers, no matter how many, does not increase or significantly change the burden and time required by the consultants to assemble the periodic clothing sets.

In certain embodiments, the clothing is selected from stock available at a variety of selected retailers, such as, for example, the Gap, Men's Warehouse, Brooks Brothers, Structure, and Eddie Bauer. Order sheets may be automatically generated by the system software and transmitted to the various retailers indicating the number of each article of clothing required in each size. In other variations, the order sheets may be fully or partially manually compiled. The packages for shipment to each subscriber are typically assembled from the clothes from the various retailers and shipped to the subscriber by service agents.

In other embodiments, the clothing can be drop shipped from each retailer directly to the subscriber. The receipt and coordination information may be sent to the subscriber separately either by mail or email. In yet other embodiments, the service may purchase clothing directly from manufacturers thereby avoiding the markup associated with retailers. Some or all of the clothing may be identified by a house brand.

### Terminology:

The terms and phrases as indicated in parenthesis (“”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase. The term “or” as used in this specification and the appended claims is not meant to be exclusive rather the term is inclusive meaning “either or both”.

References in the specification to “one embodiment”, “an embodiment”, “a preferred embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of ±20%. Also, as applicable, the term “substantially” as used herein unless otherwise indicated means a margin of ±10%. It is to be appreciated that not all uses of the above terms are quantifiable such that the referenced ranges can be applied.

The term “merchant” refers to retailers, manufacturers, wholesalers and other sources of goods/clothing purchased by the subscription service. For example, the Gap would be a merchant as would an off shore manufacturer of clothing goods.

The phrase “fashion consultant” refers to agents of the subscription service whether employees or independent contractors that select pieces of clothing to be included in a set of clothing associated with one or more lifestyle profile categories. Presumably, although not necessarily, a “fashion consultant” has skill or a talent in picking pieces of clothing that are in style as well as assembling complementary outfits of different pieces of clothing.

The phrases “lifestyle profile”, “lifestyle profile category”, “lifestyle category” and the like all relate or correspond to subscriber characteristics unrelated to a subscriber's physical characteristics or clothing sizes. Generally, in embodiments described herein the “lifestyle profile” is a categorization of subscribers' overall lifestyles. For instance, a particular subscriber may be a professional that is required to dress in a certain fashion at the office, or perhaps the subscriber likes to go clubbing and wants clothing that compliments that activity. Other subscribers may exhibit an outdoors lifestyle or a casual lifestyle and accordingly desires clothing that matches the lifestyle. Typically, the number of “lifestyle categories” are finite and limited to permit a subscription service to economically pick suitable fashionable set of clothing for a large number of subscribers

As used herein the terms “modules” and “functionality” in reference to software, software code and computer hardware are considered interchangeable. For example, credit/debit card module in a computer or microprocessor-based system whether hardware or software refers to the ability of the associated system to perform a particular function or functions related to credit/debit card processing. In contrast, the use of the term “module” does not mean the related software code be stored in a particular routine or object in the overall associated software program or system.

The phrase “set of clothing” generally refers to a particular grouping of clothing items shipped to a subscriber on a periodic basis. The phrase “ensemble of clothing” is also used herein interchangeably.

### An Exemplary Computer System

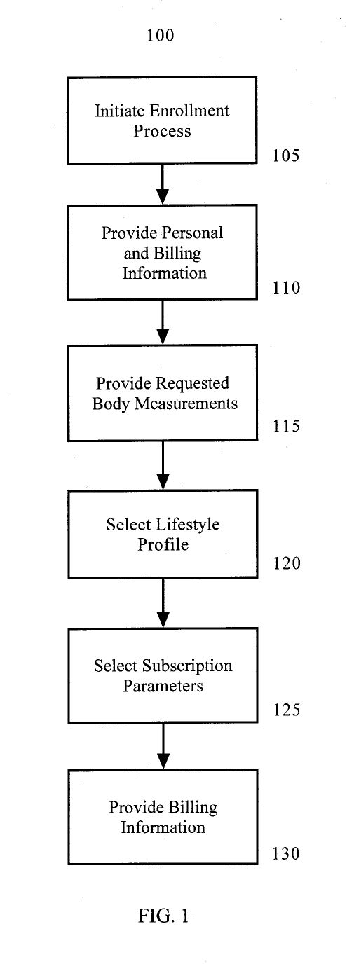

FIG. 1 illustrates an exemplary computer system 100 upon which embodiments of the invention may be implemented. The computer system can be utilized as a server upon which software and hardware resides. Additionally, the computer system can be a client from which a user accesses the server over a network connection. As contemplated herein the computer is typically coupled with a network, such as the Internet, through which a server computer and a client computer can transfer and access information through any suitable means including but not limited to web sites, email, instant messaging and wireless communications.

The computer system typically comprises a bus 110 or other communication means for communicating information, and a processing means, such as a processor 105, coupled with the bus for processing information. The typical computer system further comprises a random access memory (RAM) or other dynamically-generated storage device 115 (referred to as main memory), coupled to the bus for storing information and instructions to be executed on by the processor. The main memory 115 may also be used for storing temporary variables or other intermediate information during execution of instructions by the processor. The computer system also typically comprises read only memory (ROM) 120 and/or another static storage device coupled to the bus 110 for storing static information and instructions for the processor.

A data storage device 125, such as a magnetic disk, an optical disk and its corresponding drive, or a flash memory storage device may also be coupled to the computer system 200 for storing information and instructions. The computer system can also be coupled via the bus 110 to a display device 130, such as a cathode ray tube (CRT) or Liquid Crystal Display (LCD), for displaying information to an end user. Typically, an alphanumeric input device (keyboard) 135, including alphanumeric and other keys, may be coupled to the bus for communicating information and/or command selections to the processor 105. Another common type of user input device is cursor control device 140, such as a mouse, a trackball, a trackpad or cursor direction keys for communicating direction information and command selections to the processor and for controlling cursor movement on the display.

A communication device 145 can also coupled to the bus 110. The communication device may include a modem, a network interface card, or other well-known interface devices, such as those used for coupling to Ethernet, token ring, or other types of physical attachment for purposes of providing a communication link to support a local or wide area network, for example. The communications device may also be a wireless device for coupling to a wireless network.

It is appreciated that a lesser or more equipped computer system than the example described above may be desirable for certain implementations. Therefore, the configuration of computer system 100 will vary from implementation to implementation depending upon numerous factors, such as its intended use, price constraints, performance requirements, technological improvements, and/or other circumstances.

It should be noted that while embodiments of the subscription service and method described herein may be performed and used with a computer similar to the one described herein, other embodiments and variations can be used with other information devices, such as but not limited to PDAs, Internet Appliances, and wired and wireless telephonic communications systems. Therefore, nothing disclosed herein concerning the configuration of the illustrated computer should be construed as limiting the present invention to a particular embodiment wherein the recited operations are performed by a specific combination of hardware components.

### System for Providing Clothing by Subscription According to an Embodiment

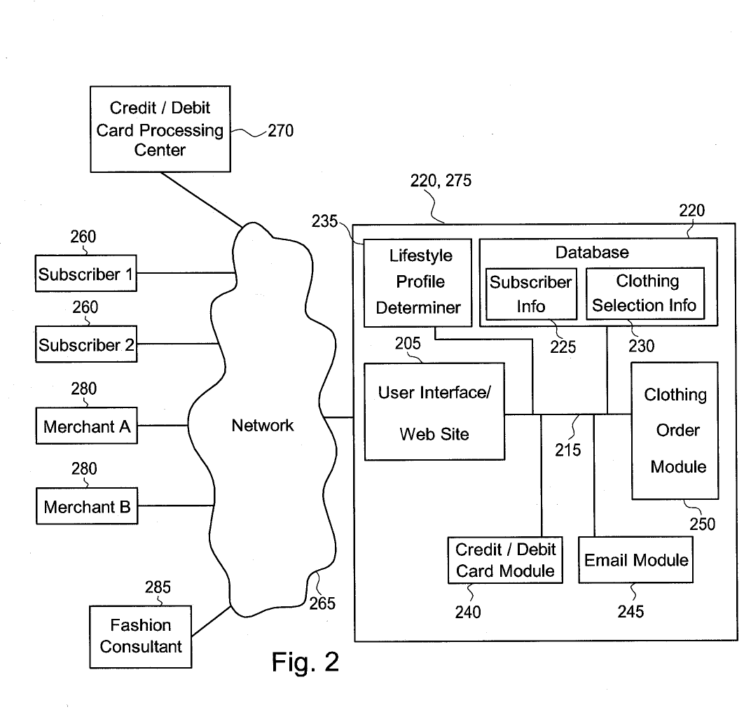

In certain embodiments, the system comprises a program typically encoded in software running on a computer 100 similar to the type described above. A prototypical system program 200 comprising a plurality of software modules is illustrated in FIG. 2. In some variations, the software modules are all resident on a single server computer 275 that is coupled to a network 265, such as but not limited to the Internet. In other variations, the various software modules can be distributed between a plurality of computers that are networked together. As illustrated herein, the system through its server computer(s) can interface with a plurality of subscribers and potential subscribers, such as the subscribers 260 indicated in FIG. 2. Typically, the system is also configured to interface with other computers coupled to the network, such as but not limited to a credit/debit card processing center 270, ordering centers for merchants through which clothing articles are purchased, and the computers of fashion consultants 285.

At the-front end, a user interface 205, which in certain variations comprises one or more web pages, is provided through which a subscriber or other user can access the referral system over the associated network 265. A prospective subscriber can access additional public pages providing one or more of the following: a description of the service and how it works, a description of sample clothing and/or outfits, subscription pricing, relevant news, frequently asked questions and enrollment information. Current subscribers are typically provided a login prompt that provides a text box for a member to enter one or both his username and password to provide access to pages and information concerning his subscription and make changes as necessary.

The various pages are operationally coupled as applicable to the various other software modules by way of a suitable interface 215 or interfaces. For instance, where the referral system comprises a single program running on a single computer 275, the modules may be routines or objects that are called or invoked by other objects or routines as required. In other variations wherein the modules are located on separate computers or wherein one or more modules is a standalone executable file on a single computer, the interface(s) 215 may comprise either or both of a bus and/or a network connection.

It is to be appreciated that the various modules provided in FIG. 2 and their organization are merely exemplary and can vary substantially depending on how the referral system is configured and constructed. For instance, modules can be stand alone applications or merely components of a larger application. The various modules can be separate and distinct from each other as illustrated or they can be integrated with each other in any reasonable and suitable configuration. Modules can be broken up into suitable sub-modules. Further, additional modules not specifically described above or illustrated can be provided. In short, the organization of the software is not intended to be limited to a particular manner of organization so long as it can execute the functionality described generally in this specification and more specifically, as applicable, in the appended claims.

One of the modules typically provided in the system is a database 220 that includes subscriber information 225 and clothing selection information 230. The database is queried as necessary by the other modules and by subscribers and other users. The subscriber information typically includes clothing size and or body measurement information for each subscriber, his lifestyle/interest profile category, his chosen subscription level, his billing information and his address. Additional information may also be associated with each subscriber relating to optional subcategories. The clothing selection information will typically include one or more listings of sets or ensembles of clothing for each of the lifestyle profiles categories chosen for one or more subscription periods. Additionally, sourcing information for each piece of clothing is typically included in the database.

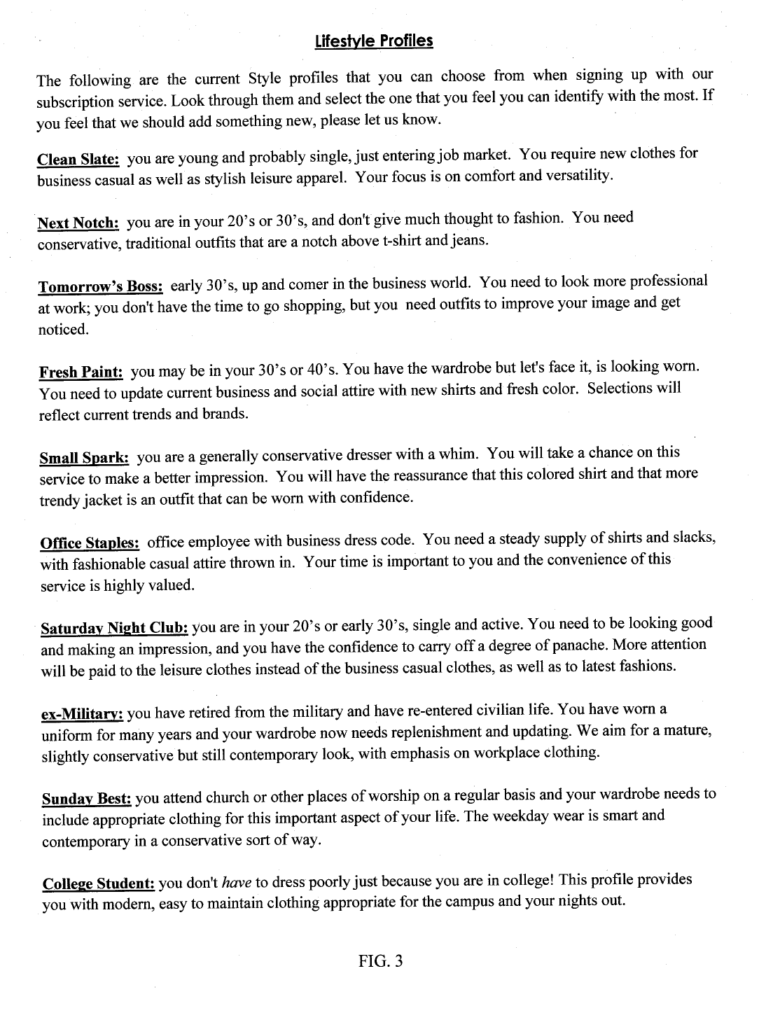

Another module typically included in the system is a lifestyle profile determiner 235 that comprises functionality adapted to assist a new subscriber in choosing the lifestyle/interest profile category that best matches with him. In a simple variation, the determiner may simply comprise a plurality of lifestyle/interest descriptions that are displayed one or more web pages in combination with a place for the new subscriber to indicate the category closest to his lifestyle. FIG. 3 is an example of a web page including a plurality of lifestyle category descriptions. In this variation, the determiner may be primarily or even completely integrated with the website/ user interface 205.

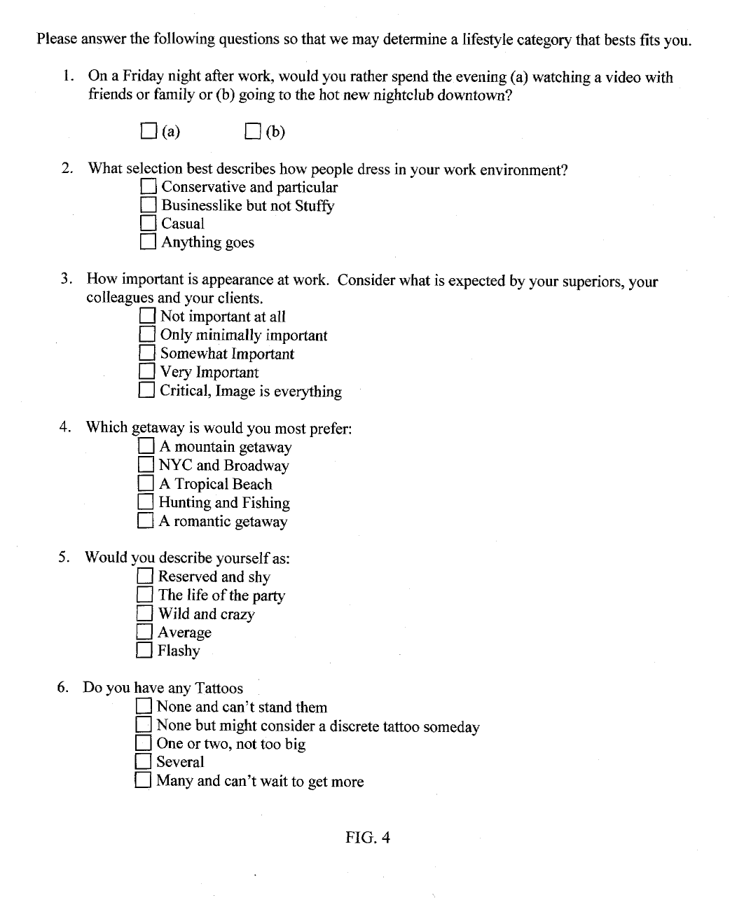

In other more complex versions, the lifestyle profile determiner 235 can comprise a questionnaire provided to a new subscriber through the user interface 205 and associated logic to tabulate and analyze the subscriber's responses to the questions and suggest or assign a lifestyle profile category to the subscriber. Samples of the type of questions that can appear on the questionnaire are provided in FIG. 4; however, this sample listing is not to be considered comprehensive or even complete as a questionnaire can have many more questions that vary considerably from those provided herein as would be obvious to one of ordinary skill in the art given the benefit of this disclosure. Typically, no matter the type of lifestyle profile determiner utilized in embodiments of the system, the lifestyle category chosen and/or selected for each subscriber is associated with the subscriber in the database 220.

The system typically includes credit/debit card charging functionality wherein a subscriber's credit or debit card is charged or debited periodically a predetermined amount relative to the subscriber's subscription level. In variations, the credit/debit card module 240 is also adapted to perform wire transfers directly from a subscriber's bank account using information provided by the subscriber. Each subscriber's card is typically automatically charged on a monthly or quarterly basis. In preferred variations, the credit/debit card module interfaces with a credit/debit card processing center 270 over the network connection 265, but in other variations the credit card module can interface with a processing center in any suitable manner such as over a telephone line. In yet other variations of the system, the credit/debit card module can be dispensed with and the subscribers' credit/debit cards can be manually processed by an agent of the entity operating the subscription clothing service, or each subscriber may be sent an invoice periodically.

An email module 245 is also typically included in the system. The email module is utilized to send information to each subscriber's email address concerning his account status as well as information concerning the clothing he has or will receive. In some variations, the email module automatically sends each subscriber a receipt after his credit/debit card is charged. In other variations, the email module will send each subscriber coordination information concerning either or both of (i) the current set of clothing shipped or to be shipped, and (ii) all clothing purchased through the subscription plan. The email module can also be used to broadcast messages to subscribers such as to notify subscribers of their subscription status, promotional events, specials and other news concerning the service.

One of the key features of embodiments of the subscription clothing service described herein is that the subscriber never picks out his own clothing but rather sets and/or ensembles are sent directly to him based on his lifestyle profile. Accordingly, someone other than the subscriber must pick the clothing associated with each lifestyle profile category. Typically, fashion consultants, who may be contractors or agents of the entity providing the subscription service, are utilized to pick the clothing that will be sent to the subscribers on a periodic basis. In some variations, the fashions consultants 285 will enter information concerning the selected clothing pieces into the clothing selection information portion 230 of the database 220 by way of the network 265 and the system's user interface 205. In other variations, the consultants themselves may never directly interface with the system but rather provide information about their clothing selections to other agents of the service, such as data entry personnel, who enter the information into the database.

In certain embodiments of the system a clothing order module 250 may be provided that automatically tabulates the total quantities of each piece of clothing in each different size that must be ordered to assemble sets of clothing for each subscriber in at least one lifestyle category and automatically by way of the network 265 places orders with the applicable merchants 280 & 285. It is appreciated that in some embodiments, the periodic shipment of sets of clothing for each lifestyle profile can be staggered such that the work load of the entity running the subscription service remains relatively constant. For example, the set of clothing for lifestyle category A may be shipped in the first week of each calendar quarter; category B may be shipped in the second; and so on with additional categories. However, in other embodiments, the sets of clothing pertaining to certain lifestyle categories may be shipped nearly contemporaneously such as where the sets of clothes relate to a particular season.

In another variation, the clothing order module 250 may not actually order the clothing from various applicable merchants but might merely query the database and generate reports and order sheets for the various pieces and numbers of clothing that need to be ordered from each merchant. The reports and order sheets can then be used by buyers to procure the necessary clothing.

### Methodology of Operating a Clothing Subscription Service According to one Embodiment

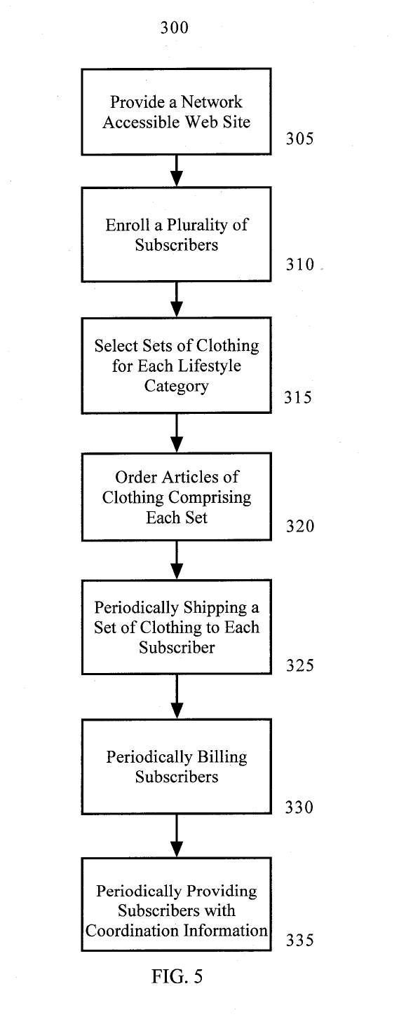

FIG. 5 is a flow diagram 300 illustrating the operation of a clothing subscription service utilizing an embodiment of the system described above.

Embodiments of the clothing subscription service system operate and rely on the availability of a suitable network 265, preferably a wide area network and even more preferably the Internet. It is through the network that prospective subscribers subscribe to the service; it is through the network that subscribers provide information concerning their clothing sizes; it is through the network that subscribers provide information that is utilized to appropriately categorize each subscriber; it is through the network that subscribers are kept abreast of their subscription status typically by way of email; and in at least some embodiments, it is through the network that subscribers' credit/debit cards are periodically and regularly billed.

As indicated in block 305, access to a network and the corresponding access to the system are typically provided by way of the aforementioned user interface 205, most typically comprising a web site. In typically embodiments, the web site will have both public and private sections wherein the public sections provide general information about the subscription service for prospective subscribers and the private portion provides current subscribers with a means of accessing and changing information related to their subscriptions and accounts. Additional private sections may be provided that permit fashion consultants and data entry specialists to retrieve and/or enter information, such as the clothing selections for a particular lifestyle category, into the database. While access is typically contemplated through a website or other GUI interface, access can also be provided through other suitable interfaces in other embodiments. For instance, a network interface can be provided that permits network to system access through a telephone through one or both of a telephone keyboard and by way of voice prompts.

Through various venues and any suitable means, prospective subscribers are encouraged to visit the web site/user interface and enroll in the service. Advertising may include but is not limited to: (i) print advertising in magazines and other print media read by members of the target market; (ii) online advertising with hyperlinks to the subscription service website; (iii) print material provided at partner merchants; and (iv) sponsorship of promotional events likely to be attended by members of the target market. In some variations, live agents may be utilized to explain the system to prospective subscribers and potentially enroll them.

One of the primary purposes of the website/user interface is to enroll new subscribers and obtain necessary information concerning each subscriber as indicated in block 310. By using a website or other means to direct and guide a new subscriber through the subscription process, cost intensive labor is minimized. One of the biggest issues with currently providing clothing that is custom selected to both fit a customer and also meet his particular lifestyle needs is that a large amount of manpower is typically required. For example, a clerk can typically only assist a single customer at time. In embodiments of the subscription service, the website combined with the categorization of subscribers based on their lifestyle and interest profiles allows the custom selection of clothing for a subscriber that meets his particular needs without a huge expenditure in manpower. The end result is a stylish look for the subscribers at a reasonable cost while providing lower overhead for the subscription service.

In at least one embodiment, the target market comprises single professional men. As discussed above, many single men have difficulty choosing clothing for themselves. They often lack a sense of style and often find it difficult to coordinate clothing outfits. By using the embodiment of the service, the single male subscriber can rest assured that he is regularly and periodically receiving sets of clothes that are stylish and suitable for his lifestyle. Where coordination information is provided, the subscriber can take comfort in knowing that the pieces of clothing he selects to wear on any given day do not clash or otherwise appear inappropriate in combination. Furthermore, because of the reduced labor requirements (i.e. no clerk is required to assist the subscriber in the clothing selection), he can assemble a wardrobe at a reasonable level of expenditure. Finally, and not least, because the subscriber does not participate in the selection of his clothes, he does not have to spend the time or deal with the frustration of shopping.

In other variations, the service can be adapted to other groups including but not limited to single professional women, married men, married women, children and even the general population. Furthermore, other variations are contemplated wherein the products being sold via the subscription service are not clothing but other types of products that are amenable to having a third party make a selection based on a user's lifestyle profile.

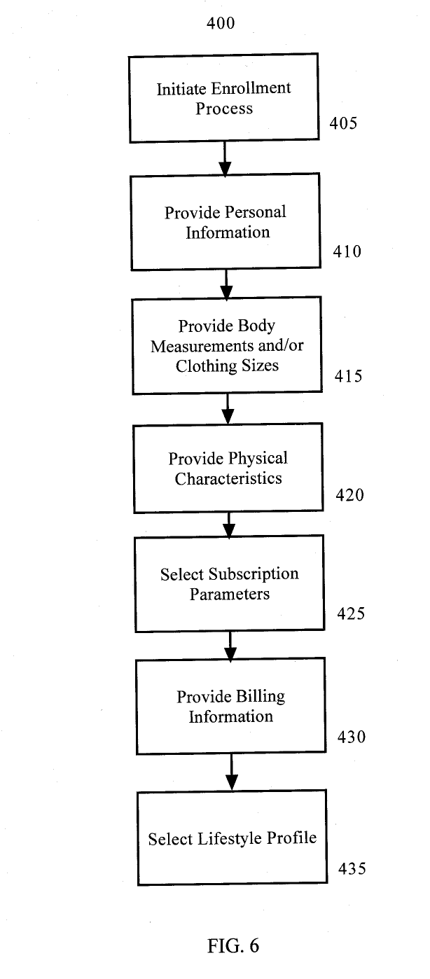

The process of enrolling a subscriber of the plurality of subscribers is illustrated in the block diagram 400 of FIG. 6. Referring to block 405, the enrollment process is initiated by a prospective subscriber or an agent of the subscriber (for example, a wife, girlfriend or mother of the subscriber). In embodiments using a web site user interface 205, the prospective subscriber clicks the appropriate box or icon on one of the system's pages to begin the subscription process. After initiating the process, one or more web pages are provided that guide the new subscriber through the process. Where a telephonic user interface is utilized, the subscriber typically calls an appropriate telephone number and responds to the prompt to initiate the subscription process. Additional voice prompts are provided to guide the new subscriber through the enrollment process.

As indicated in block 410, personal information is solicited from the new subscriber, such as, but not limited to, identifying information, such as the user's name and age, and address. As indicated in block 415, clothing size information is solicited, which can include the subscriber's body measurements and/or the sizes of clothing he typically wears. In some embodiments, the physical characteristics of the subscriber are solicited as indicated in block 420. The physical characteristics can include, but are not limited to, body type and hair, eye and skin color. The physical characteristic information is utilized in some variations to adjust or tailor the lifestyle category clothing sets into one or more subcategories.

Next, subscription parameters are solicited from the new subscriber as indicated in block 425. Subscription parameters can include various options such as but not limited to: (i) the amount to be spent on each set of clothing (various price levels can be offered such as $50 or $ 100 a month); (ii) the spacing in time between deliveries of sets of clothing (e.g. monthly or quarterly); and (iii) the frequency of billing the subscriber (e.g. monthly, quarterly, annually). Referring to block 430, billing information is also solicited. Billing information will typically comprise the subscriber's credit/debit card information but alternatively may include the subscriber's bank information to facilitate automatic withdraws. In yet other variations, the service may provide the subscriber with the option of being billed periodically instead of having the funds automatically withdrawn or charged. Additionally, as indicated in block 435 and discussed in greater detail below, the subscriber's lifestyle profile category, and as applicable subcategory, are determined.

In certain embodiments and variations, other information may be solicited in addition to that listed above. For instance, information may be solicited concerning the climate where the subscriber either or both resides or frequents. Based on this additional information, a subscriber can be assigned a particular subcategory.

As or after the requested information is gathered about a new subscriber, it is stored in the database and associated with the subscriber. In certain embodiments, the information is used by the automated system for a variety of purposes, such as generating order sheets for all subscribers within a particular category based on clothing sizes and subcategory information, generating emails to each of the various subscribers containing billing and clothing information including coordination information, and automatically charging or debiting a subscriber's credit/debit card.

Typically, upon enrollment a subscriber is provided or is asked to provide a user name and password. Accordingly, the subscriber can sign on to the system via the user interface at a future time and modify his information as necessary. For instance, he may need to change address and/or billing information, he may want to change subscription parameters, or he may want to change his lifestyle profile category.

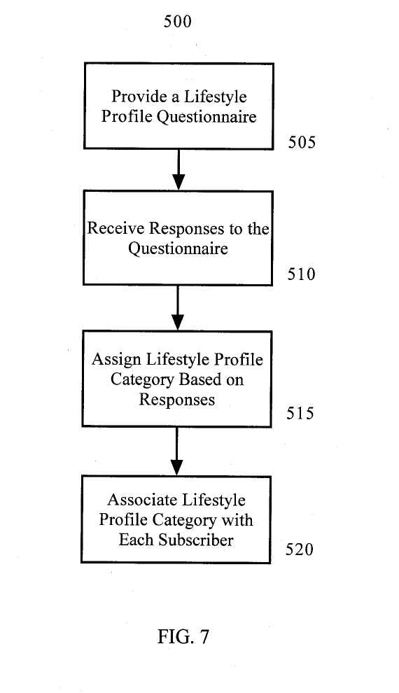

As mentioned above, an important aspect of the new subscriber enrollment process is placing each subscriber into one of a finite set of lifestyle profile categories. As described above with reference to FIG. 4, the selection of the appropriate category may comprise no more than providing a new subscriber with a listing of different lifestyle categories and having him select one. However, in other embodiments and variations, the category selection may be determined by the system based on a subscriber's answer to a variety of questions posed in an online questionnaire as detailed in the block diagram 500 of FIG. 7.

Referring to block 505, the system provides the subscriber with a lifestyle profile questionnaire by way of the user interface. In some embodiments, the questionnaire is presented on one or more web pages provided through the user interface/website 205. The questionnaire may have questions similar to the sample questions provided in FIG. 5 or different questions altogether. In embodiments, the subscriber responds to each question by checking a box associated with a plurality of answer choices. In other embodiments or variations, the subscriber responds by typing in an appropriate answer which may comprise a letter, a number or a suitable text response. In some variations of the web pages, a series of questions can be provided on a single page or in others a single question may be provided on each page with the site automatically advancing to the next question when a previous question is answered.

In some embodiments, the user interface, as discussed above, can comprise an automated voice system accessible by way of a telephone or similar device. With a voice based questionnaire, the questions are typically asked of the subscriber and he responds either using his telephone keypad or by speaking the answers into the headset microphone.

The answers to the questions are received and stored in system memory as indicated in block 510. Next, typically upon completion of the questionnaire, the answers are processed by the system to determine the lifestyle category that best matches the subscriber as indicated in block 515. The methodology applied by the system to determine the appropriate category can comprise any suitable algorithm as would be known or obvious to one of ordinary skill in the art to which the invention pertains. For instance, point values may be assigned to each answer to each question and the category for a particular subscriber may be determined based on the total numerical result from summing the point values for all the answers.

Finally, the lifestyle category that corresponds to each subscriber is associated with the subscriber as indicated in block 520. Typically, the lifestyle profile category for each subscriber is stored in the database and associated with the subscriber. As discussed below, each subscriber is grouped with other subscribers based on his assigned lifestyle profile category.

Referring back to FIG. 5 as indicated in block 315, sets and/or ensembles of clothing are selected for each lifestyle category on a regular and periodic basis by the service's fashion consultants. Further in some embodiments, the clothing selections may be further refined for each subcategory defined within a particular lifestyle category. As discussed above, the fashion consultants pick sets and ensembles of clothing based only on the particulars of each lifestyle category and subcategory and do not base the selections on any particular preferences of any of the subscribers. The subscribers have no input into the clothing selection process other than the information they provided during the enrollment process (or subsequent editing of their information).

By limiting the number of categories to a finite number, a relatively small number of fashion consultants can select sets of clothing for thousands, tens of thousands, hundreds of thousands and/or millions of subscribers that are appropriate and in-style for a substantial majority if not all of the subscribers. In one embodiment aimed at young single professional men, 7 categories are provided as shown in FIG. 4. The total number of categories and subcategories can vary depending on the embodiment and the target audience of the particular embodiment but generally less than 100 total categories is preferred, less than 50 categories is more preferred and less than 30 categories is most preferred.

In some embodiments, subcategories of the lifestyle profile categories are used to further refine clothing selection for members belonging to a particular subcategory. For instance, a lifestyle category may include subcategories for warm and cold climates and adjust the periodic selections based on the climate. Other subcategories may adjust the color of the clothing selections based on subscriber physical characteristics such as but not limited to eye color, skin tone, and hair color.

The clothing selection process can occur in any number of ways. For instance, a fashion consultant may be assigned a single category or he/she may be assigned multiple categories. Typically, the fashion consultant is expected to be someone who has a strong sense of fashion, knows what is currently in style and can coordinate clothing ensembles. In some variations, the fashion consultant may be given free reign to pick clothing from any retail source(s) he/she desires typically constrained only by the dollar amount of subscription. In other variations, the service may form partnerships with certain retailers, such as Banana Republic, Brook Brothers and Structures and the fashion consultant may be constrained to choosing from the selection at the partner retailers.

Selecting clothing directly from known retailers could reduce the number of pieces of clothing available for a certain dollar amount if the service pays full retail for the clothing. It is appreciated a certain portion of the dollar amount allocated for clothing for any particular subscriber in a particular subscription period is retained by the service as a service fee. The service fee typically covers the expense of operating the subscription service system, compensating the fashion consultants and other contractors or agents, and presumably providing a profit for the service. Accordingly, in certain embodiments, the fashion consultants, service buyers, or other agents may negotiate better than retail pricing with the retailers especially those that partner with the subscription service. Given that thousands of units of any one clothing piece may be ordered, the service can often negotiate savings close to or in excess of the service fee: the net result being that a subscriber will get as many if not more pieces of clothing for his dollar than if he purchased them directly from the various retailers.

In yet other embodiments, the service may source some or all of the clothing directly from a manufacturing and label the clothing as a house brand. In this embodiment, the consultants, buyers, and other agents provide the manufacturers with designs they desire to have produced in large quantities. These private label pieces are likely to be less expensive than retail branded pieces thereby providing a subscriber with more clothing for his subscription amount. However, some subscribers may prefer brand name clothing. In some variations, house brand clothing may be mixed with name brand pieces. In other variations, a subscriber will be able to pick whether he prefers the brand name or house option.

After or during selection of the various pieces of clothing for a set, the fashion consultant or other agent of the service typically enters the relevant information into the system database. Typically, the database entry for each piece of clothing includes: (i) the lifestyle category and subcategories to which it is defined; (ii) the available sizes; (iii) the per unit cost; (iv) other pieces of clothing to which the piece is matched; (v) the retailer or wholesaler to be used and ordering information and (vi) any notes concerning the clothing and its use that may be provided by the fashion consultants.

Whatever methodology is utilized in sourcing the various pieces of clothing for a particular lifestyle profile or group of lifestyle profiles, the various pieces comprising a set are ordered for each member of the applicable lifestyle profile category or subcategory in advance of the delivery target date(s) as indicated in block 320.

In embodiments, order lists for a particular category or subcategory are generated by the database based on: (i) the number of subscribers within the category or subcategory; (ii) the different sizes required for each subscriber of each piece of clothing; and (iii) the sources from which the clothing is to be purchased. In certain variations, such as those where a partnership has been established with one or more retailers, the clothing ordering module may in addition to generating the order lists also automatically and directly transmit the orders to the various retailers/merchants over the network 265. The automatically transmitted orders can comprise mere lists with no particular formatting, or they can be configured to interface with the ordering systems of the various retailers/merchants. In other variations, the order lists generated by the order module through a query of the database are forwarded to buyers or other service agents who place the orders for the various pieces manually.

It is to be appreciated that the clothing order module 250 can include or interface with order management software as is commercially available. Order management software can be used to track the status of the various orders and identify potential problems that must be resolved in order to ensure shipments of the various sets of clothing to the subscribers occurs in a timely fashion.

Under the subscription model, subscribers will be sent sets of clothing on a regular basis as indicated in block 320. In certain embodiments, sets of clothing are sent quarterly. In other embodiments, sets of clothing can be sent monthly, every other month or any other desired period. For example, a man subscribing to the service for a year at $100 a month will receive set of clothing every quarter over a year. By years end the total amount of clothing received by the subscriber could include: 1 pair of jeans; 3 pairs of khaki pants; 2 dress pants; 2 pair of shorts; 1 belt; 2 T-shirts; 3 polo shirts; 2 short sleeved cotton shirts; 4 long sleeved shirts; 2 dress shirts; 1 tie; 1 sweater; 1 mock T-shirt; 1 sweater polo and 1 blazer. Of course, the foregoing list is only exemplary and the actual assortment of clothing can vary substantially and significantly depending on a subscriber's lifestyle category and the types of clothing that are in style at the time of the subscription.

In some embodiments, the clothes are drop shipped directly from the various retailers/merchants to the subscribers. Accordingly, a particular periodic set of clothing may arrive in two or more packages. In other embodiments, the clothing can be shipped to the service where agents and/or employees of the subscription service, assemble and package the sets of clothing and ship them to the subscribers.

As indicated in FIG. 5 block 330, the subscriber is periodically billed for the clothes. The subscriber may be billed quarterly or monthly contemporaneously with the shipment of the set of clothing. Alternatively, the reoccurring billing period may differ from the period shipment of clothing. For instance, the subscriber may to be billed in equal monthly increments but the clothing sets are shipped quarterly. In other variations, the subscriber may be billed the entire subscription amount up front for a year or other suitable period. A discount may also be given for complete up front payment. Typically, as indicated above, the subscriber's credit/debit card is automatically charged via the debit/credit module 240 through the associated network 265.

Finally, as indicated in block 335, coordination information, typically prepared by the fashion consultants, may be provided to each subscriber indicating outfits that can be created from the provided clothing. For instance, a particular set of clothing may include several pants and several shirts, and the coordination information will indicate which of the shirts complement which of the pants. Accordingly, a subscriber need not worry whether certain combinations of clothes go together so long as he follows and abides by the provided information. In some embodiments the coordination information pertains only to a particular set of clothing. In other embodiments, the coordination information may pertain to all clothing shipped within a particular period, such as the current subscription year or the past twelve months. In yet other embodiments, the coordination information can be provided for the entire period the subscriber has been a subscriber.

In certain embodiments, the coordination information is sent to the subscriber via email typically along with his current statement/invoice for the most recent shipment of clothing. In other variations, the information can be sent by the post separate from the shipment of the set of clothing. In yet other variations, such as those where the set of clothing is assembled by agents of the service and sent as a single package, the coordination information can be sent with the set of clothing in the same package.

### Other Embodiments and Variations

The various embodiments and variations thereof illustrated in the accompanying Figures and/or described above are merely exemplary and are not meant to limit the scope of the invention. It is to be appreciated that numerous variations of the invention have been contemplated as would be obvious to one of ordinary skill in the art with the benefit of this disclosure. For instance, the order in which the various operations occur as provided in the various figures and as described herein can vary as is practical without deviating from the scope or breadth of the invention.

While the embodiments described specifically herein above relate primarily to single professional men, the target subscriber can be from any suitable group including married men, single or married women or even children. Further, the invention is described in relation to clothing but the concept described herein can be applied to other groupings of goods as would be obvious to one of ordinary skill in the art to which this invention pertains.

As stated above, the specific organization of the system can vary significantly and substantially. For instance, the various modules (or functionality) can be distributed over a plurality of servers. In yet another embodiment, the methodology of the subscription service can be implemented without requiring subscribers to access a network connection, such as the internet. For instance, a prospective subscriber could fill out a subscription application that includes all the information necessary for enrollment, and all correspondence between the service and the subscriber can occur via the post.

I claim:

1. A method relating to a subscription service for the clothing, the method comprising:
enrolling a subscriber;
determining a lifestyle profile for the subscriber;
receiving size information concerning the subscriber
periodically selecting a set of clothing for the subscriber based on the lifestyle profile and size information without the subscriber seeing or approving of the chosen clothing; and
causing the merchandise to be delivered to the subscriber.

2. The method of claim 1, wherein the subscriber is enrolled through a web site.

3. The method of claim 1, wherein determining the interest/lifestyle profile further comprises: providing a questionnaire on a web site; receiving responses to questions on the questionnaire from the subscriber; and automatically assigning the lifestyle profile based on the responses.

4. The method of claim 1, wherein determining the lifestyle profile further comprises: providing a listing of lifestyle profiles on a web site; receiving a lifestyle profile selection from the subscriber; and assigning the selected lifestyle profile to the subscriber.

5. The method of claim 1, further comprising receiving information concerning one or more of the following attributes associated with or related to the subscriber: eye color; hair color; body type; skin hue; and the region of and climate at a domicile of the subscriber.

6. The method of claim 1, further comprising:
periodically charging a credit card provided by the subscriber.

7. The method of claim 5, further comprising varying the set of clothing based on one or more of the attributes.

8. A method of selling clothing, the method comprising:
providing a user interface accessible over a communications network;
enrolling a plurality of subscribers by way of the user interface including receiving and storing information related to each subscriber concerning clothing sizes of each subscriber;
based on information provided by each subscriber of the plurality of subscribers over the communications network, automatically assigning each subscriber to one of a finite set of lifestyle profiles;
periodically selecting a plurality of sets of clothing tailored to each lifestyle profile without additional input from any of the plurality of subscribers; and
periodically and regularly causing a set of articles of clothing tailored to a subscriber's assigned lifestyle profile and size to be delivered to each subscriber of the plurality of subscribers.

9. The method of claim 8, wherein the “periodically and regularly causing” operation occurs one of monthly and quarterly.

10. The method of claim 8, wherein the “enrolling a plurality of subscribers” operation further comprises: receiving a selection of the each subscriber's periodic budget selection from two or more choices.

11. The method of claim 8, further comprising:
ordering articles of clothing for each set of clothing of the plurality of sets from a plurality of merchants based on the number of subscribers assigned to the lifestyle profile associated with each set.

12. The method of claim 11 wherein the operation of “periodically and regularly causing a set of clothing tailored to a subscriber's assigned lifestyle profile to be delivered to each subscriber of the plurality of subscribers” includes directing each of the plurality of merchants to deliver applicable articles of clothing directly to each subscriber.

13. The method of claim 11 wherein the operation of “periodically and regularly causing a set of clothing tailored to a subscriber's assigned lifestyle profile to be delivered to each subscriber of the plurality of subscribers” includes compiling packages for each subscriber comprising the set of clothing associated with the subscriber's lifestyle profile in the subscriber's sizes and shipping the set to the subscriber.

14. The method of claim 8, wherein the operation of “automatically assigning each subscriber to one of a finite set of lifestyle profiles” further includes: (i) providing a questionnaire on a web site; and (ii) receiving responses to questions on the questionnaire from each subscriber.

15. The method of claim 8, wherein the operation of “automatically assigning each subscriber to one of a finite set of lifestyle profiles” further includes: (i) providing a listing of interest/lifestyle profiles on a web site; and (ii) receiving an interest/lifestyle profile selection from each subscriber.

16. The method of claim 8, further comprising:
automatically tabulating on a periodic basis the number of each article of clothing in each size required for all subscribers assigned a particular lifestyle profile from a database including (i) data for each subscriber assigned the particular lifestyle profile and (ii) the articles of clothing included in each set associated with the particular lifestyle profile; and
processing one or more orders on a periodic basis for the articles of clothing required to assemble sets of articles of clothing for each subscriber associated with the particular lifestyle profile.

17. A method of providing clothes to plurality of people by way of subscription, the method comprising: (i) categorizing each person of the plurality of people based on the person's lifestyle in a finite number of profile categories; (ii) associating clothing size information for each person of the plurality of people; (iii) periodically assembling an ensemble of clothing for each profile categories; and (iv) periodically and regularly shipping an ensemble of clothing to each person based on the person's profile category.

18. The method of claim 17, further comprising charging each person of the plurality of people a predetermined amount on a periodic basis.

19. The method of claim 18, further comprising providing coordination information concerning the pieces included in the ensemble of clothing to each person of the plurality of people.

20. The method of claim 19, further comprising target marketing the subscription service to single professional men.
